(19) United States
(12) Patent Application Publication
(10) Pub. No.: US 2007/0109397 A1
(43) Pub. Date: May 17, 2007

(54) Video play mobile telephone and video play method in a broadband network

(75) Inventors: Ning Yuan, Beijing (CN); Hong Wei, Beijing (CN)

Correspondence Address: HARNESS, DICKEY & PIERCE, P.L.C., P.O. BOX 828, BLOOMFIELD HILLS, MI, 48303, US

(73) Assignees: Ning Yuan, (CN); Su Yuan, Beijing (CN)

(21) Appl. No.: 10/563,723

(22) PCT Filed: Jun. 30, 2004
(86) PCT No.: PCT/CN04/00710

§ 371 Date: May 23, 2006

(30) Foreign Application Priority Data
Jul. 7, 2003 (CN) 03148578.2

(51) Int. Cl. H04N 7/14

(52) U.S. Cl. 348/14.02

(57) ABSTRACT

The present invention discloses a video play mobile telephone in broadband network, comprising: a video player, for isolating a video signal and a sound signal from a received signal; a video projector comprising data format converting means for converting a data format of the video signal isolated by the video player, data rate converting means for converting a data transmission rate of the video signal isolated by the video player, photoelectric converting means for converting the data format converted and data rate converted video signal into an optical signal; and projecting means for projecting the optical signal onto a projection plane. According to the invention, the video signal is projected to the projection plane and thus can be viewed more clearly and visually.

### FIELD OF THE INVENTION

The present invention relates to a mobile telephone in a wireless broadband network.

### BACKGROUND OF THE INVENTION

With the development of wireless communication CDMA techniques, many mobile telephone standards in the broadband network have been proposed, such as TD-SCDMA, W-CDMA and CDMA 2000. The mobile telephone in the broadband network is currently referred to as a 3G mobile telephone (i.e. the third generation mobile telephone). A problem of bandwidth definition thus occurs. Generally speaking, the broadband network mobile telephone that has a transmission rate more than 128 kb/s and is capable of transmitting 4 visual image data frames per second, is considered as a broadband network 3G mobile telephone. The broadband 3G mobile telephone and the current narrowband CDMA mobile telephone have a similar signal transmission mode, but are much different in transmission rate. That is, in a same unit time, the transmission data amount of the broadband 3G mobile telephone is greatly higher than that of the current narrowband CDMA mobile telephone. Accordingly, it is possible to achieve the transmission of radio signals by a broadband network, the bandwidth of which is enough to transmit high traffic services such as radio voice signals, image signals and computer networking. Heretofore, the 3G mobile telephone can only display image signals through a display screen of the mobile telephone itself, and thus can not display video images more clearly and visually.

### SUMMARY OF THE INVENTION

An object of the invention is to provide a video play mobile telephone and video play method in broadband network, which projects video signals onto a projection plane so as to view the video signals more clearly and visually.

According to one aspect of the invention, a video play mobile telephone in broadband network is provided, comprising:
a video player, for isolating a video signal and a sound signal from a received signal;
a video projector comprising:
   data format converting means for converting a data format of the video signal isolated by the video player,
   data rate converting means for converting a data transmission rate of the video signal isolated by the video player,
   photoelectric converting means for converting the data format converted and data rate converted video signal into an optical signal; and
   projecting means for projecting the optical signal onto a projection plane.

According to another aspect of the invention, a method of playing video by using a broadband network video play mobile telephone is provided, comprising the steps of:
receiving a radio signal by the broadband network image play mobile telephone;
isolating a video signal and a sound signal from the signal received by a video player in the broadband network image play mobile telephone;
converting a data format of the video signal isolated by the video player, and converting a data transmission rate of the video signal isolated by the video player, in order to meet projection requirements of a video projector in the broadband network image play mobile telephone;
converting the data format converted and data rate converted video signal into an optical signal, and projecting the optical signal onto a projection plane, by the video projector.

According to a basic concept of the invention, by using the bandwidth advantage of the 3G mobile telephone per se, the visual image and sound data transmitted by the broadband radio network are received. The received broadband radio signal passes through an operation amplifer and an A/D converter to convert an analog signal into a digital signal that is decoded by a decoder and is decompressed to isolate corresponding video and sound signals there from. The extracted video signal needs to be re-processed to meet the data format and corresponding rate required by the video projector, for example, RGB (Red, Green and Blue display signal) signal format. The video projector receives the RGB signal and photoelectrically converts it to obtain a visual optical signal. Then, the projecting means of the video projector continuously projects the visual optical signal onto the projection plane to display dynamic image signals.

The broadband network video play mobile telephone is generated for the main reason of the bandwidth advantage of the mobile telephone in the broadband CDMA or other broadband networks. By using the broadband network mobile telephone having the video projector to play the visual optical signal, the real time dynamic image play such as movie, television or networking, can be reached, thus avoiding the limitation of physical volume of the mobile telephone. The image information can be projected in the form of visual light by the video projector in the mobile telephone, and certain degree of control and browsing capabilities could be achieved by using keyboard of the mobile telephone. The present invention is somewhat similar to a movie projector, but uses the mobile telephone as a video projecting body. On the premise that the volume of the mobile telephone is not enlarged too much, the video projector is integrated within the mobile telephone to project the image in the form of light and form a certain area of optical video, onto any planar object opposite to the mobile telephone, so as to enable the image visual. The broadband network mobile telephone player can play movies, televisions or networking at any time and any place, in the coverage of the signal of the broadband network mobile telephone, such that the defect of the screen of the mobile telephone being too small is avoided.

The present invention is an extension of the use of the present 3G broadband mobile telephone and 3G concept mobile telephone, which is a component of a future 3G visual mobile telephone and can be integrated into the 3G mobile telephone.

### BRIEF DESCRIPTION OF THE DRAWINGS

FIG. 1 is a schematic diagram showing video play of the broadband network mobile telephone comprising the video projector according to the invention; and

FIG. 2 is a schematic diagram showing an operation of the broadband network mobile telephone according to the invention.

### DETAILED DESCRIPTION OF THE PREFERRED EMBODIMENT

The broadband network image play mobile telephone according to the invention will be described below in conjunction with the accompanying drawings.

Since there are many broadband CDMA standards, it is difficult to decide which structure is more suitable and the invention will be described with a common design approach. DSP (digital signal processor) plus FPGA (field programmable gate array) structure has the following main features: flexible structure, stronger all-propose, adapted to module design, improved operation efficiency, shorter development period, easy to maintain and extend, and adapted to communication real time signal processing. Since the physical channel processing of the mobile telephone is the processing directed to real time signals, the real time signal processing system should have the capability of processing mass data to ensure the real time feature of the system. In addition, the volume, power consumption and stability of the system are also strictly required. The real time signal is generally processed by DSP that is a combination of hardware and algorithms in itself and has a higher demand on the algorithms. Processing of different levels and different types such as summation and abstraction operations are often used in the algorithms. For the communication data transmission, part of operations have relatively simper structures but have a higher computing speed demand due to mass data and high repetition. Therefore, DSP is used with the cooperation of FPGA hardware structure to achieve high speed data processing. Part of operations have no special demand on speed, but have comparatively complex computing methods and control structures, are difficult to be solely implemented by hardware, and thus need the cooperation of the DSP software. The transmission of visual image data is actually the processing on the real time signal system. The real time signal processing system is a complex information process system that has a high demand on computing speed and contains many kinds of operations.

A signal receiving process of the broadband network video play mobile telephone according to the invention will be described below:
(1) using a 3G (such as broadband CDMA) mobile telephone and base station as a medium for transmitting broadband signals;
(2) after a visual signal reaches the image player of the broadband network mobile telephone, it is demodulated, decoded and decompressed into a visual data stream, by an analog front-end, a central process unit and other peripheral circuits (DSP+FPGA), for example, video data formats such as MPEG_{—}4.

A specific process is as follows:

Since a wireless broadband mobile telephone is divided into an uplink and a downlink, by taking WCDMA FDD mode as an example, the frequency band occupied by the system comprises:
the downlink (from the base station to the mobile telephone): 2110-2170 MHZ;
the uplink (from the mobile telephone to the base station): 1920-1980 MHZ;
channel width: 5 MHz; and inter-channel space: 200 kHz.

Since the channel width reaches 5 MHz, a corresponding base is provided for the wireless broadband network to transmit visual image data. The signal receiving process is in the downlink (from the base station to the mobile telephone). First of all, the base station must transmit a broadband radio signal containing the video data signal. Secondly, the 3G mobile telephone must possess the capability of receiving the broadband radio data signal. A receiving antenna is used for receiving wireless broadband analog complex data. The received complex signal is amplified by a RF amplifier. The received RF modulated data (for example, QPSK modulation mode or QAM modulation mode) is RF demodulated to different ranges of frequency band that are combined by a RF frequency combiner. The wireless broadband analog complex data is converted by D/A conversion into a compressed digital complex data. A broadband CDMA encoding processor demodulates and decompresses the broadband complex data, corrects the data, and isolates the complex data to obtain the voice signal, video signal and corresponding sound signal.

After the visual data stream is decompressed, the data stream needs to be re-processed to meet the data stream format of the video player. The video speed is in inversely proportional to resolution, i.e. the value of the resolution displayed in the same video speed determines the definition of display frames. That is to say, the larger the resolution is, the image is displayed more clearly. However, since video input rate is fixed, in order to reach the continuously visual video rate, i.e. 24 frames per second, the decompressed visual data stream needs to be re-processed. In the present invention, the data format of the video signal isolated by the video player is converted through a data rate converting means in the video projector, and the data transmission rate of the video signal isolated by the video player is converted by a data rate converting means. For instance, the visual data stream is received by FPGA and converted so as to meet the data stream format of the video play system, for example, RGB format. Then, the visual data stream is transmitted to a photoelectric converting means in the video projector that converts the data format converted and data rate converted video signal into an optical signal that is projected by a projecting means, for example, a three primary color projecting means (similar to the current projector), to be a visual signal.

According to the invention, the use of the keyboard of the broadband network mobile telephone can control a cursor and a part of information, for example, functions such as channel exchanging, network browsing, mouse moving and clicking. The mobile telephone of the invention also has a function of storing a part of images. The volume of the mobile telephone is small enough as the current mobile telephone. It is to be noted that, the broadband network video play mobile telephone of the invention requires sufficient battery power to maintain video play time of 2 to 3 hours.

A transmitting process of the broadband network video play mobile telephone is as follows:
(1) Similar to the mobile telephone that can transmit static images like pictures, the broadband network video play mobile telephone has the function of transmitting visual images in real time;
(2) Visual signal collection. The visual signal collects external dynamic information through a lens of the broadband network video play mobile telephone;
(3) A/D converting, compressing, broadband CDMA protocol encoding and signal modulating the dynamic real time visual signal;
(4) Encoding and transmitting the visual signal to a nearest base station; and
(5) For web pages, browsing short messages and transmitting short message service signals back.

The basic design flow is as follows:

Broadband network protocol determination (TD_SCDMA, WCDMA, CDMA2000, etc.), physical layer design (hardware structure design) and software design (design such as software structure and algorithms).

Functional division of DSP and FPGA (DSP mainly performs complex algorithms and system control, and FPGA mainly performs protocol mating and high speed signal processing, etc.); demodulating mode, A/D conversion, decompression mode; signal classification (voice signal, video signal and corresponding sound signal); extracting the video signal and sound signal (to which the invention is primarily directed, other signals are omitted herein); the video and sound signal being converted by FPGA to meet the RGB signal stream and format; the RGB signal being transmitted to the video projecting means to be converted into a visual optical signal; the visual optical signal is projected out via the lens; the visual optical signal reaching a plane to form a visual optical image; additionally processing the sound signal; since the visual signal needs a time X to be RGB and photoelectrically converted, the sound signal must be delayed the same time X to be played synchronously with the visual signal.

There are many ways to extract images, DSP+FPGA is merely one of them, and other ways may be used, comprising hardware ASIC (Application Specific Integrated Circuit) mode and DSP+ASIC mode. No matter how to extract the video image, the image must be converted into the image adapted to the play standard of the video projector.

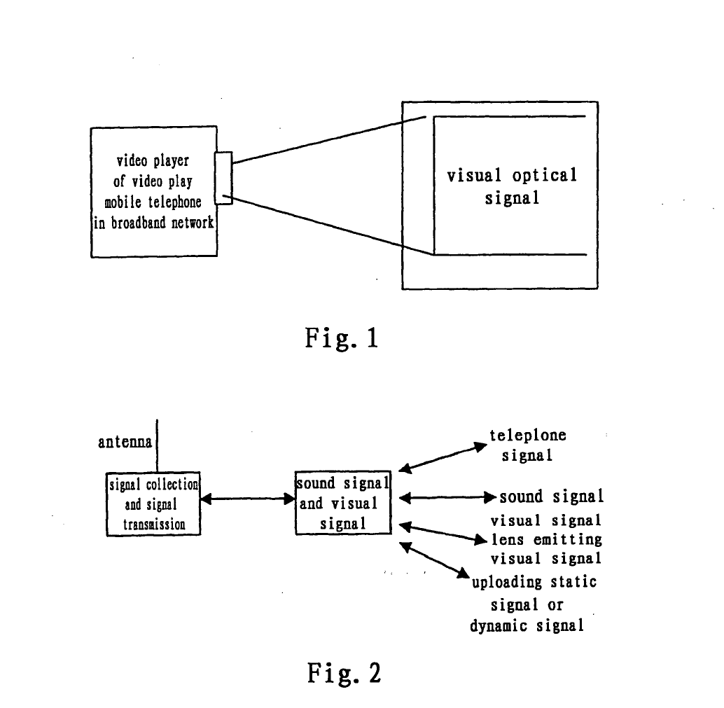

FIG. 1 is a schematic diagram showing the video projected by the broadband network mobile telephone containing the video projector according to the invention. In FIG. 1, the broadband network mobile telephone projects the visual optical signal onto a projection plane to display the visual optical signal, thereby forming a dynamic image on the projection plane.

FIG. 2 is a schematic diagram showing the operation of the broadband network mobile telephone according to the invention. In FIG. 2, the broadband network mobile telephone receives the broadband radio signal provided by the broadband network and containing the video signal, converts the broadband radio signal to extract the video signal and the sound signal in synchronization with the video signal. Then, the extracted video signal is photoelectrically converted by the video projector to obtain the visual optical signal. Subsequently, the projecting means of the video projector projects the visual optical signal onto the projection plane to display the dynamic image signal.

The broadband network mobile telephone according to the present invention does not affect telephone call while projecting video, which not only reserves original telephone functions, but also records external visual signals and uploads the external visual signals to a corresponding receiving equipment for real time signal recording, or photographs static images, for example, pictures.

A signal receiving way of the broadband network video projecting mobile telephone as shown in FIG. 2 will be described below.

The signal receiving way of the broadband network video play mobile telephone is as follows:

The broadband network video play mobile telephone of the invention receives via the antenna of the mobile telephone the visual image and sound data transmitted by the broadband radio network, subjects the received broadband radio signal to an operation amplifier and an A/D converter to convert the analog signal into a digital signal, decodes the digital signal by a decoder, and demodulates and decompresses the digital signal to isolate corresponding video and sound signals from the digital signal. For the extracted video signal, since its data format and data transmission rate do not meet the requirement of the video projector, they need to be re-processed to be converted into the data format and corresponding rate that meet the video projector's requirement, for example, RGB (Red, Green and Blue display signal) signal format. The video projector receives the RGB signal and photoelectrically converts the RGB signal to obtain the visual optical signal. Then, the projecting means of the video projector continuously projects the visual optical signal onto the projection plane to display the dynamic image signals.

The broadband network video play mobile telephone according to the present invention and the present 3G and broadband CDMA mobile telephone are the same in the technique for isolating the corresponding video signal and sound signal form the received signal, but are different in that, the present 3G and broadband CDMA mobile telephone play the visual signal though a liquid crystal display screen of the mobile telephone, while the broadband network video play mobile telephone of the invention further comprises an integrated video projector for projecting the isolated video signal and sound signal onto an external projection plane.

A specific implementing process is as follows:

The condition for implementing is that, first of all, a visual signal transmitting station is needed for transmitting the visual signal and the sound signal in synchronization with the visual signal; secondly, the mobile telephone must have the capability of receiving the visual signal and sound signal of broadband network.
1. Similar to the basic design flow, since there are many kinds of broadband network protocols (TD_SCDMA, WCDMA, CDMA2000) and the design of physical layer of the various protocols are different, details of their software designs (designs such as software structure and algorithms) are different, but the overall design principle and basic concept remain unchanged.

Broadband network protocol determination (TD_SCDMA, WCDMA, CDMA2000, etc.); physical layer design (hardware structure definition); software design (design such as software structure and algorithms); functional division of DSP and FPGA (DSP mainly performs complex algorithms and system control, and FPGA mainly performs protocol mating and high speed signal processing, etc.); demodulating mode, A/D conversion, decompression mode; signal classification (voice signal, video signal and corresponding sound signal); extracting the video signal and sound signal (to which the invention is primarily directed, other signals are omitted herein); the video and sound signal being converted by FPGA to meet the RGB signal stream and format; the RGB signal being transmitted to the video projecting means to be converted into a visual optical signal; the visual optical signal is projected out via the lens; the visual optical signal reaching a plane to form a visual optical image; additionally processing the sound signal; since the visual signal needs a time X to be RGB and photoelectrically converted, the sound signal must be delayed the same time X to be played synchronously with the visual signal.

There are many ways to extract images, DSP+FPGA is merely one of them, and other ways may be used, comprising hardware ASIC (Application Specific Integrated Circuit) mode and DSP+ASIC mode. No matter how to extract the video image, the image must be converted into an image adapted to the RGB play standard of the video projector. The visual electric signal (RGB signal) is connected by a cable or circuit board wire to a receiving terminal of the integrated video projector within the broadband network video play mobile telephone.
2. The broadband network video play mobile telephone receives the visual electric signal (RGB signal) and encodes and converts the received visual electric signal into a visual optical signal.
3. The visual optical signal is subjected to steps such as focusing and amplifying, to be converted into a visual light through the lens.
4. When the visual light illuminates a certain plane, such as a white wall, a black and white or colorful image is generated.

A signal transmitting process of the broadband network video play mobile telephone of the invention will be described below:

The signal transmitting process is an inverse process of the signal receiving process. The process firstly comprises: visual signal collecting, web page browsing, short message service signal back-transmitting and a part of control signal back-transmitting, to partially control the played visual image and sound signal. The visual signal collects the external dynamic information through the lens of the broadband network video play mobile telephone. The dynamic real time visual signal is A/D converted, compressed, broadband CDMA protocol encoded, and modulated. The visual signal is encoded and transmitted to a nearest base station.

1. A video play mobile telephone in broadband network, comprising:
a video player, for isolating a video signal and a sound signal from a received signal;
a video projector comprising:
data format converting means for converting a data format of the video signal isolated by the video player,
data rate converting means for converting a data transmission rate of the video signal isolated by the video player,
photoelectric converting means for converting the data format converted and data rate converted video signal into an optical signal; and
projecting means for projecting the optical signal onto a projection plane.

2. The video play mobile telephone in broadband network as defined in claim 1, further comprising sound signal delaying means for delaying the sound signal to be in synchronization with the video signal projected onto the projection plane.

3. The video play mobile telephone in broadband network as defined in claim 1, wherein said data format converted and data rate converted video signal is a Red Green Blue display signal.

4. A method for playing video by using a broadband network video play mobile telephone, comprising the steps of:
receiving a radio signal by the broadband network image play mobile telephone;
isolating a video signal and a sound signal from the signal received by a video player in the broadband network image play mobile telephone;
converting a data format of the video signal isolated by the video player, and converting a data transmission rate of the video signal isolated by the video player, in order to meet projection requirements of a video projector in the broadband network image play mobile telephone;
converting the data format converted and data rate converted video signal into an optical signal, and projecting the optical signal onto a projection plane, by the video projector.

5. The method as defined in claim 4, further comprising the step of delaying the sound signal to be in synchronization with the video signal projected onto the projection plane.
